(19) United States
(12) Patent Application Publication
(10) Pub. No.: US 2019/0232555 A1
(43) Pub. Date: Aug. 1, 2019

(54) ADDITIVELY-MANUFACTURED PERIODIC STRUCTURES TO ACHIEVE EFFECTIVE LOW-K MATERIALS IN RF APPLICATIONS

(71) Applicant: BAE SYSTEMS Information and Electronic Systems Integration Inc., Nashua, NH (US)

(72) Inventors: Michael J. SHAW, Epsom, NH (US); Michael D. BLAZEJ, Mont Vernon, NH (US); Andrew R. CUTTS, Plaistow, NH (US); Frank N. MAKRIDES, Belmont, MA (US); Patrick D. McKIVERGAN, Londonderry, NH (US); Athanasios E. PASHOS, Pembroke, NH (US)

(21) Appl. No.: 15/886,114

(22) Filed: Feb. 1, 2018

(51) Int. Cl. B29C 64/124; H01Q 1/42; B33Y 10/00; B33Y 70/00

(52) U.S. Cl. CPC B29C 64/124; H01Q 1/42; H01Q 17/00; B33Y 70/00; B33Y 10/00

(57) ABSTRACT

A method for forming three-dimensional periodic lattice structures through the use of additive manufacturing to achieve engineered, application specific, effective material properties that differ from that of the bulk host 3d-printable material for radio frequency (RF) applications including radomes and antenna apertures. Such structures remain mechanically robust while offering access to a range of material properties not available otherwise through the engineering of detailed wave-propagation characteristics through such lattice structures.

### STATEMENT OF GOVERNMENT INTEREST

This disclosure was made with United States Government support under Contract No. 6533773795 awarded by the Department of the Navy. The United States Government has certain rights in this disclosure.

### FIELD OF THE DISCLOSURE

The present disclosure relates to low-K materials for use in radio frequency applications and more particularly to additively manufactured periodic structures for use in radomes and other radio frequency applications.

### BACKGROUND OF THE DISCLOSURE

Specialized materials, such as syntactic foams, are used in a host of commercial and military radio frequency (RF) applications as a structural or semi-structural element. Very commonly these materials are used to provide mechanical support while remaining transparent to the RF radiation being transmitted or received. These materials are commonly used in RF antenna radomes and other RF beam-shaping devices. What makes these materials ideal for these applications is the fact that they have very low permittivity (e.g. “Low-K”) and low loss. However, these materials often start out as a powder and must undergo a series of labor-intensive and costly processes to be formed into the final complex shape needed for these RF applications.

Wherefore it is an object of the present disclosure to overcome the above- mentioned shortcomings and drawbacks associated with conventional low-K materials for use in radio frequency applications, such as syntactic foams.

### SUMMARY OF THE DISCLOSURE

One aspect of the present disclosure is a method of manufacturing periodic structures to achieve effective low-k and low loss materials in radio frequency applications comprising: providing a layer of bulk material; providing a subsequent layer of bulk material onto the layer of bulk material; bonding the layer of bulk material to the subsequent layer of bulk material using additive manufacturing methods; and repeating the process to form a three-dimensional component comprising a lattice and having an overall dielectric constant that is lower than that of the bulk material.

One embodiment of the method of manufacturing periodic structures to achieve effective low-k and low loss materials in radio frequency applications is wherein the lattice comprises repeating unit cells.

Another embodiment of the method of manufacturing periodic structures to achieve effective low-k and low loss materials in radio frequency applications is wherein the additive manufacturing method is stereolithography. In some cases, the bulk material further comprises a dopant.

In certain embodiments, the component is a radome and/or antenna aperture. In some cases, the periodic structure further comprises a spatial gradient.

Another aspect of the present disclosure is a periodic structure for use in radio frequency applications comprising: a three-dimensional component manufactured using additive manufacturing comprising a lattice and having a dielectric constant that is lower than that of a bulk material used to manufacture the component.

One embodiment of the periodic structure for use in radio frequency applications is wherein the lattice comprises repeating unit cells. In some cases, the method of additive manufacturing is stereolithography.

Another embodiment of the periodic structure for use in radio frequency applications is wherein the bulk material further comprises a dopant. In certain embodiments, the component is a radome. In some cases, the periodic structure further comprises a gradient.

These aspects of the disclosure are not meant to be exclusive and other features, aspects, and advantages of the present disclosure will be readily apparent to those of ordinary skill in the art when read in conjunction with the following description, appended claims, and accompanying drawings.

### BRIEF DESCRIPTION OF THE DRAWINGS

The foregoing and other objects, features, and advantages of the disclosure will be apparent from the following description of particular embodiments of the disclosure, as illustrated in the accompanying drawings in which like reference characters refer to the same parts throughout the different views. The drawings are not necessarily to scale, emphasis instead being placed upon illustrating the principles of the disclosure.

FIG. 1A is a diagrammatic view of one embodiment of a periodic structure having low-K according to the principles of the present disclosure.

FIG. 1B is a magnified view of a portion of the diagrammatic view of one embodiment of a periodic structure having low-K shown in FIG. 1A according to the principles of the present disclosure.

FIG. 1C is a plot of predicted versus measured dielectric constants for one embodiment of the present disclosure with a truncated octahedron lattice as shown in FIG. 1A and FIG. 1B.

FIG. 1D is a plot of predicted versus measured loss tangents for one embodiment of the present disclosure with a truncated octahedron lattice as shown in FIG. 1A and FIG. 1B.

FIG. 2A is a plot of dielectric constants for several materials according to the principles of the present disclosure.

FIG. 2B is an image of one embodiment of a gradient lattice according to the principles of the present disclosure.

FIG. 3A is image of two embodiments of a periodic structure having low-K according to the principles of the present disclosure.

FIG. 3B is a diagrammatic view of another embodiment of a periodic structure having low-K according to the principles of the present disclosure.

FIG. 3C is a plot of dielectric constants for a bulk material versus one embodiment of the present disclosure with an octet truss lattice as shown in FIG. 3B.

FIG. 3D is a plot of loss tangents of a bulk material versus one embodiment of the present disclosure with an octet truss lattice as shown in FIG. 3B.

FIG. 4 is a cross sectional view of one embodiment of a radome according to the principles of the present disclosure.

FIG. 5 is a perspective view of the cross sectional view of the embodiment of a radome shown in FIG. 4 according to the principles of the present disclosure.

FIG. 6 is a perspective view of one embodiment of a radome according to the principles of the present disclosure, with the outer skin removed.

FIG. 7 is an expanded perspective view of one embodiment of a radome as shown in FIG. 6 according to the principles of the present disclosure, with the outer skin removed.

### DETAILED DESCRIPTION OF THE DISCLOSURE

A radome is a structural, weatherproof enclosure that protects a radar antenna. A radome is generally constructed of material that minimally attenuates the electromagnetic signal transmitted or received by the antenna, so as to be effectively transparent to radio waves. In one embodiment of the present disclosure, additive manufacturing is used to create complex shapes necessary for such application with an inexpensive automated process. However, current materials used in additive manufacturing do not have the required RF material properties (i.e., low-K) in their bulk form as compared to traditional syntactic foams to allow for direct replacement of the traditional low-K materials.

Thus, in certain embodiments of the present disclosure additive manufacturing allows for the direct fabrication of very complex geometries such as uniform and non-uniform (i.e. gradient) periodic lattice structures. By carefully engineering these complex lattice structures, being largely comprised of air, the arbitrarily shaped RF components can be fabricated such that they possess effective material properties that are custom tuned and dissimilar from the properties of the host bulk material while remaining mechanically robust.

In some cases, unit cell sizes and the geometry of the periodic structure are engineered to achieve the desired wave propagation characteristics for the specific frequencies of operation. It is also worth noting that the addition of various RF-relevant dopant materials to the 3D-printable bulk material may significantly extend the effective RF material properties for a resultant structure leading to a variety of other new applications. For example, the addition of carbon-based dopants (e.g. dispersed carbon nanotubes) into a 3D-printable host material could have significant advantages in RF absorbing applications (e.g. superior anechoic chamber design). Additionally, the use of high-dielectric ceramic materials, in powder form, could be doped into the 3D-printable host material at specific concentrations to fine-tune the effective properties of the cellular lattice structure or extend the operating range.

The solution of the present disclosure is superior to traditional uses of low-K RF foam materials because it is fabricated in a single automated process and hence could have significant advantages in material costs, labor costs, system performance and manufacturing time in addition to being customizable for specific applications. In essence, the described method offers access to a continuous range of material properties that are not offered on the commercial market.

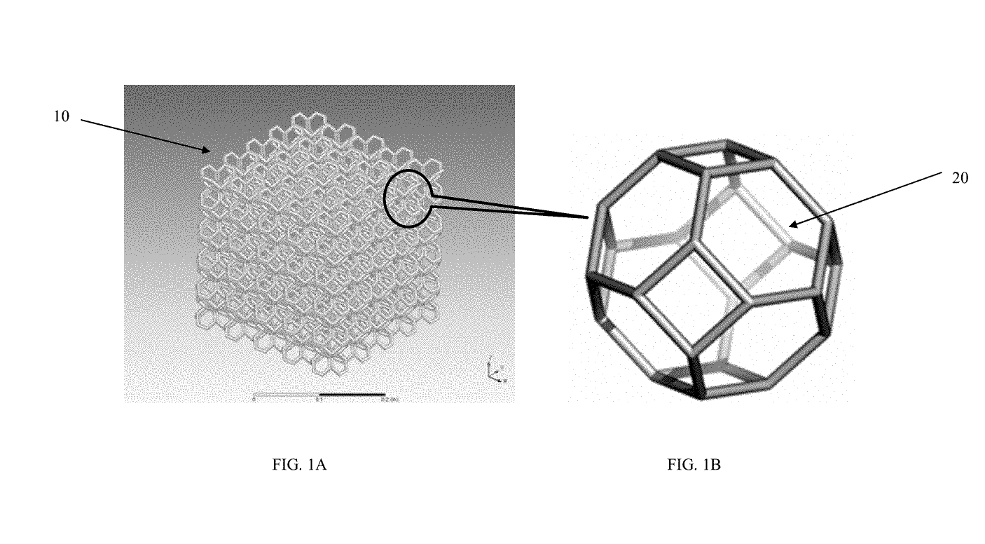

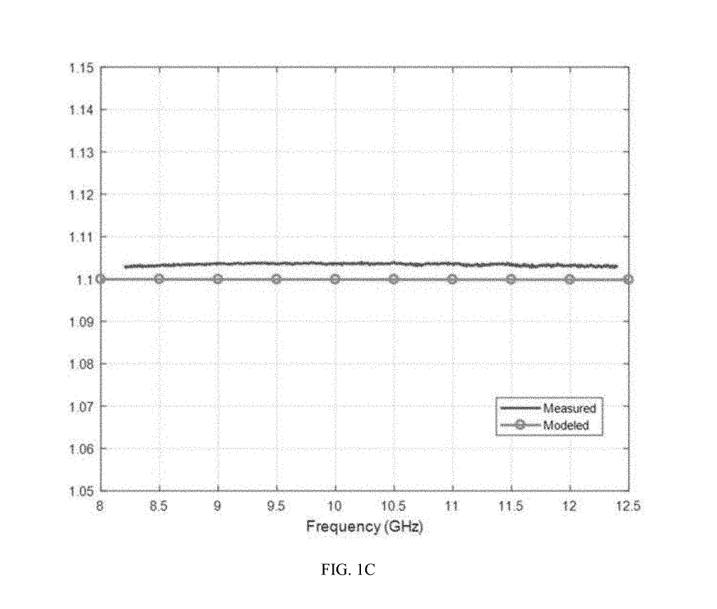

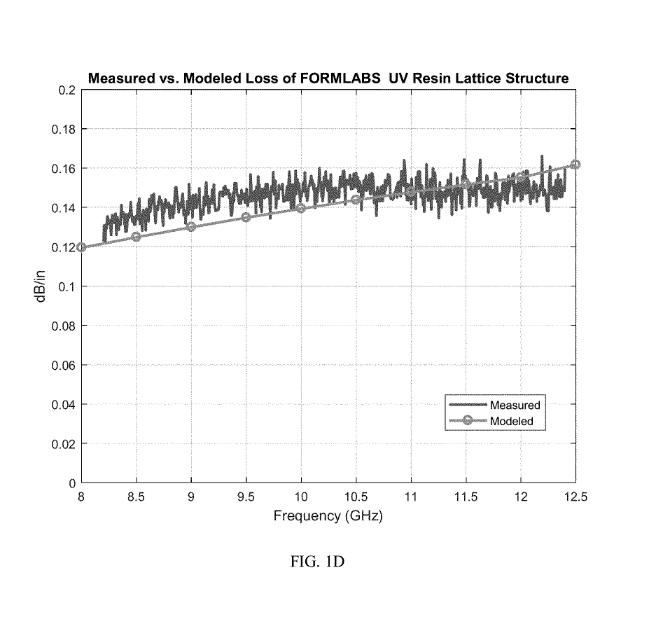

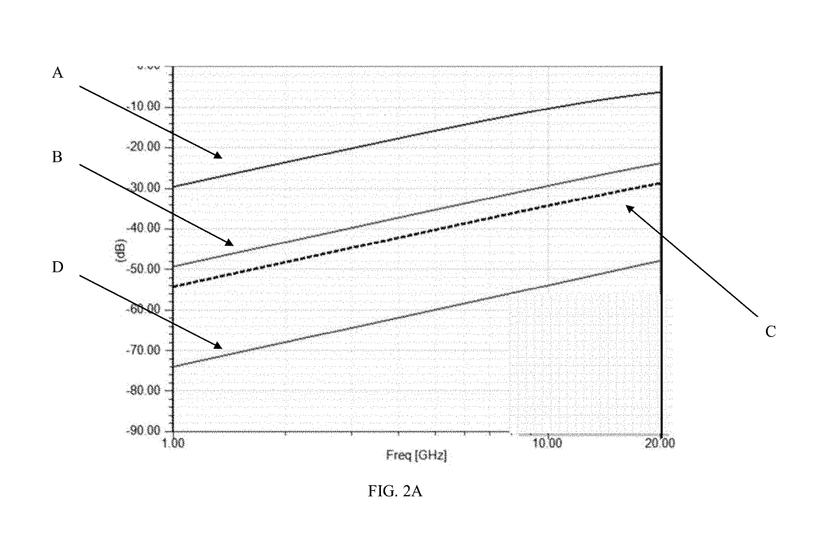

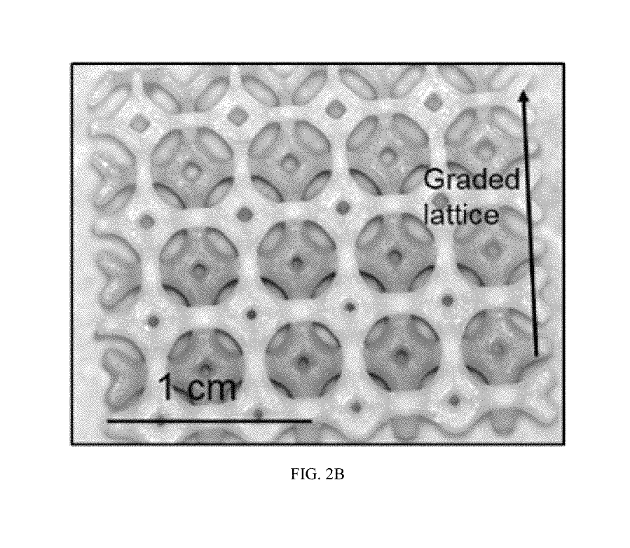

Referring to FIG. 1A, a diagrammatic view of one embodiment of a periodic structure having low-K according to the principles of the present disclosure is shown. More specifically, a periodic structure 10 is shown having been manufactured using additive manufacturing. In certain embodiments, the periodic structure has a single repeating unit cell (shown circled) throughout the entirety of the structure to form a lattice. In other embodiments, a gradient can be created by utilizing different sized unit cells, and different sized strut widths, in different regions of the structure. See, for example, FIG. 2B. In yet other embodiments, a gradient might be formed by utilizing unit cells of differing Bravais lattices, and the like.

Referring to FIG. 1B, a magnified view of a portion of the diagrammatic view of one embodiment of a periodic structure having low-K shown in FIG. 1A according to the principles of the present disclosure is shown. More specifically, a unit cell 20 is shown as a truncated octahedron. The lattice structure formed using the unit cell produced a structure that is largely air. In some cases, particular unit cells provide different mechanical strength and behavior. In certain cases, particular unit cell choices provide anisotropic RF behavior. Referring to FIG. 1C, a plot of predicted versus measured dielectric constants for one embodiment of the present disclosure with a truncated octahedron lattice as shown in FIG. 1A and FIG. 1B is shown. Referring to FIG. 1D, a plot of predicted versus measured loss tangents for one embodiment of the present disclosure with a truncated octahedron lattice as shown in FIG. 1A and FIG. 1B is shown.

Referring to FIG. 2A, a plot of dielectric constants for several materials according to the principles of the present disclosure is shown. More particularly, the top line, A, is a plot showing the dielectric constant of a bulk 3D-printable material used in one embodiment of the present disclosure. This bulk material was ULTEM, or a polyetherimide, fabricated via the material extrusion additive manufacturing process. The dielectric constant (εᵣ) for bulk ULTEM is nominally 3.3 for the RF frequencies of interest. The next line, B, is a plot showing the dielectric constant of typical syntactic foam according to the principles of the present disclosure. In this case, the syntactic foam was EX-1541, a cyanate ester syntactic foam having a dielectric constant of 1.24. The next line, C, is a plot showing the dielectric constant of one embodiment of a ULTEM lattice according to the principles of the present disclosure. This embodiment is even better than that of conventional syntactic foams as it has a lower K. In this case, the ULTEM lattice had a dielectric constant of about 1.15. The last line, D, is a plot showing the dielectric constant for air, which is considered the ideal in these RF applications. The dielectric constant for air is about 1.01. Additionally, other commercially available UV sensitive photopolymer resins were studied, some of which were produced via a stereo lithography (SLA) process.

Referring to FIG. 2B, an image of one embodiment of a gradient lattice according to the principles of the present disclosure is shown. More specifically, it can be seen that the process according to the principles of the present disclosure provides for tunability of the lattice including, as in this example, by tuning the thickness of the trusses. In this image the top of the lattice trusses are thinner than that of the trusses shown in the bottom of the image. This is just one example of tunability possible using the principles of the present disclosure.

One aspect of the present disclosure is to take advantage of additive manufacturing's ability to generate extraordinarily complex 3-dimensional geometries to create engineered material property behavior unavailable in today's commercially-available market. One opportunity is to eliminate the need for low dielectric foam as a mechanically structural, “RF-transparent” material. Use of 3-dimensional periodic lattice structures of appropriate unit cell size, based on required RF performance, to define volume fraction of bulk material-to-air ratio in order to achieve low overall dielectric constant and loss while maintaining required structural integrity and mechanical support is one benefit of the present disclosure. In one embodiment, tuning geometric parameters could achieve RF properties along a continuous spectrum from bulk material to very near air.

Additive manufacturing methods are numerous and include, but are not limited to vat photopolymerization methods, material extrusion methods, material jetting methods, binder jetting methods, power bed fusion methods, direct energy deposition methods, sheet lamination, and the like. It is understood that the method of additive manufacturing chosen is based, in part, on the bulk material and other properties needed for a particular RF application.

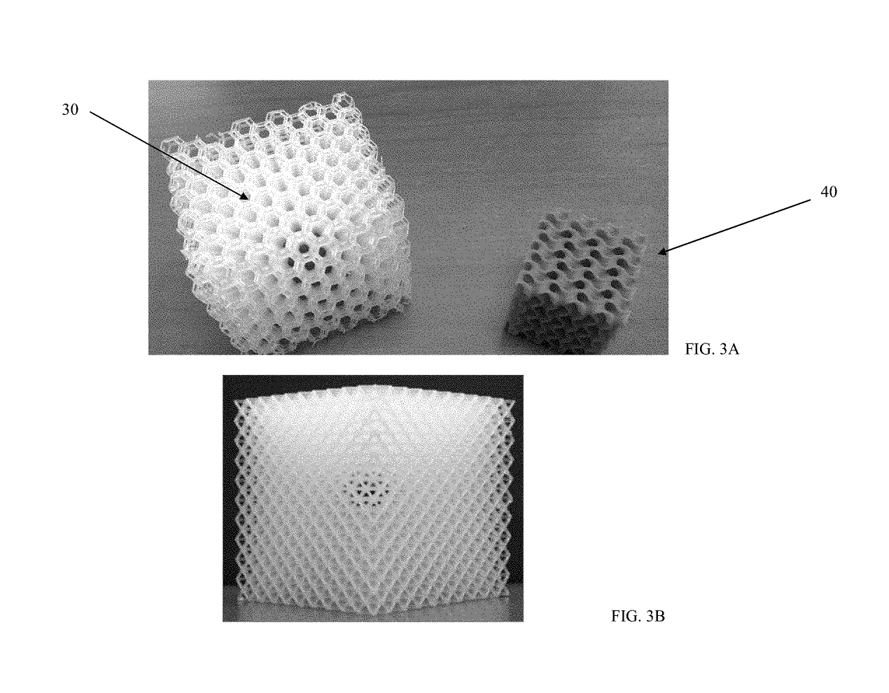

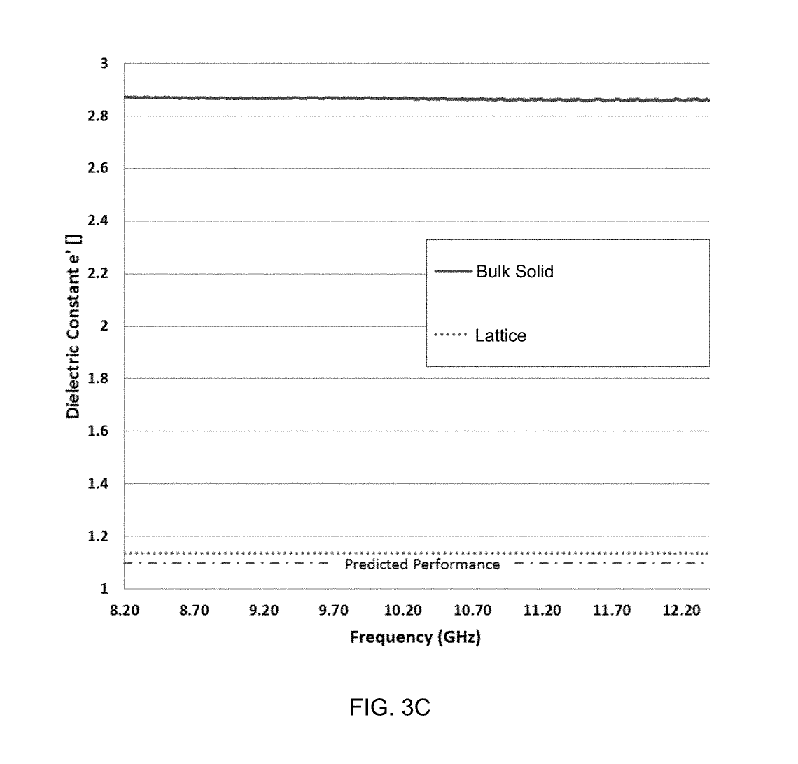

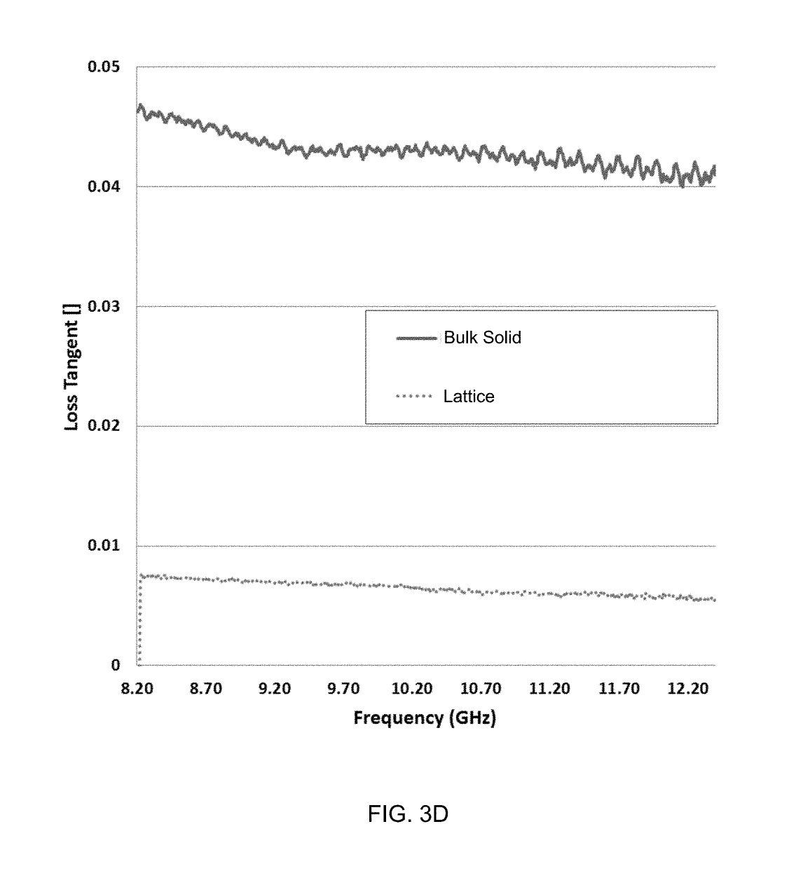

Referring to FIG. 3A, an image of additional embodiments of a periodic structures having low-K according to the principles of the present disclosure is shown. More specifically, the image on the left is a truncated octahedron unit cell printed using a stereo lithography (SLA) additive manufacturing process as further shown in FIG. 1A and FIG. 1B. The image on the right is a gyroid unit cell formed from a different bulk material also using a stereo lithography (SLA) additive manufacturing process. Referring to FIG. 3B, a diagrammatic view of another embodiment of a periodic structure having low-K according to the principles of the present disclosure is shown. This embodiment has an octet truss unit cell.

Referring to FIG. 3C, a plot of dielectric constants for the bulk material versus one embodiment of the present disclosure with an octet truss lattice as shown in FIG. 3B is shown. It is clear that a great improvement over bulk material is shown with the reduction of dielectric constant approaching that of air.

Referring to FIG. 3D, a plot of loss tangents of a bulk material versus one embodiment of the present disclosure with an octet truss lattice as shown in FIG. 3B is shown. There, a reduction in loss tangent is also seen in the lattice as compared to the bulk material for this embodiment.

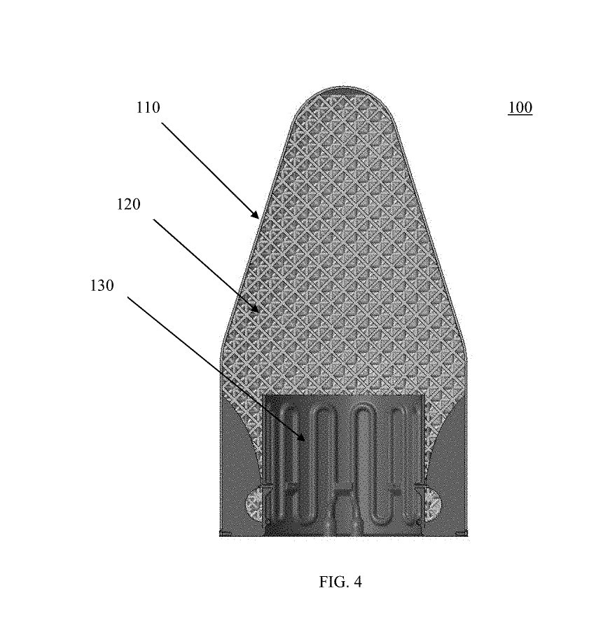

Referring to FIG. 4, a cross sectional view of one embodiment of a radome application according to the principles of the present disclosure is shown. More specifically, the radome has an integrated aerodynamic and weatherproof outer skin 110 and has an internal cavity comprising a lattice structure 120 that provides structural support with low K. The radome also has an RF antenna array 130. Current technology requires multiple steps to manufacture a radome of this type. Traditionally, multi-piece fixtures and molds, along with composite tooling, would need to be fabricated in order to form the appropriate final shape of the radome. The antenna would be placed inside a mold in which the raw syntactic foam material, in powder form, would be tamped in place, compressed, heated in an autoclave, and then trimmed via CNC machining. This process would result in only the interior of the radome being manufactured which would completely encapsulate the antenna, limiting future possibilities for re-work. Additionally, composite tooling would need to be fabricated to form the solid outer shell in a composite laminate material like fiber glass or carbon fiber. The traditional method of manufacture is costly and timely requiring several tooling fixtures, jigs, and molds to be fabricated before fabrication of the actual end-use items can even begin.

What takes a technician about eight hours to produce using current techniques will only requires about a five minute assembly step according to the principles of the present disclosure, as the radome 120 and the skin 110 can be manufactured using additive manufacturing as a single part with no required tooling. Depending on several aspects including, but not limited to, the lattice structure chosen, the bulk material used, any dopants present, and the like, a low-K radome can be manufactured in a very short time, all while having superior application-specific properties (e.g., Low-K, absorbing, etc.). Further, the entire radome can be manufactured in a single piece despite the complexity of the shape needed for the particular application. Once the radome is manufactured the RF antenna array is simply inserted into the radome using standard fastening or bonding techniques.

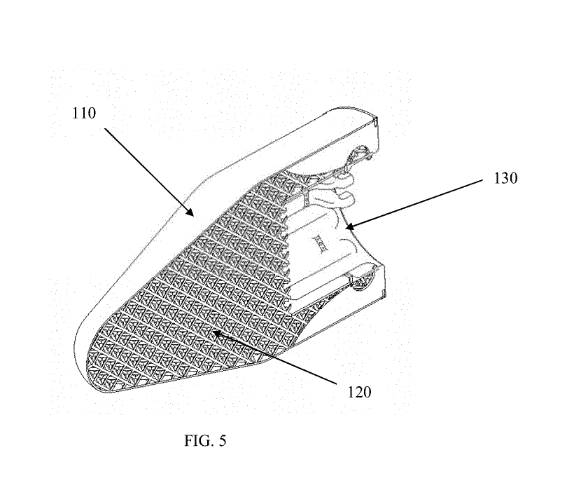

Referring to FIG. 5, a perspective view of the cross sectional view of one embodiment of a radome shown in FIG. 4 according to the principles of the present disclosure is shown. More particularly, an outer skin 110 is shown surrounding an inner lattice structure 120. A separate RF antenna array 130 is also shown. In one embodiment, the skin and the radome are manufactured of the same material. In certain embodiments, the skin and the radome and the antenna array are all manufactured using additive manufacturing. The skin is generally smooth as it is used in application where aerodynamics is preferred.

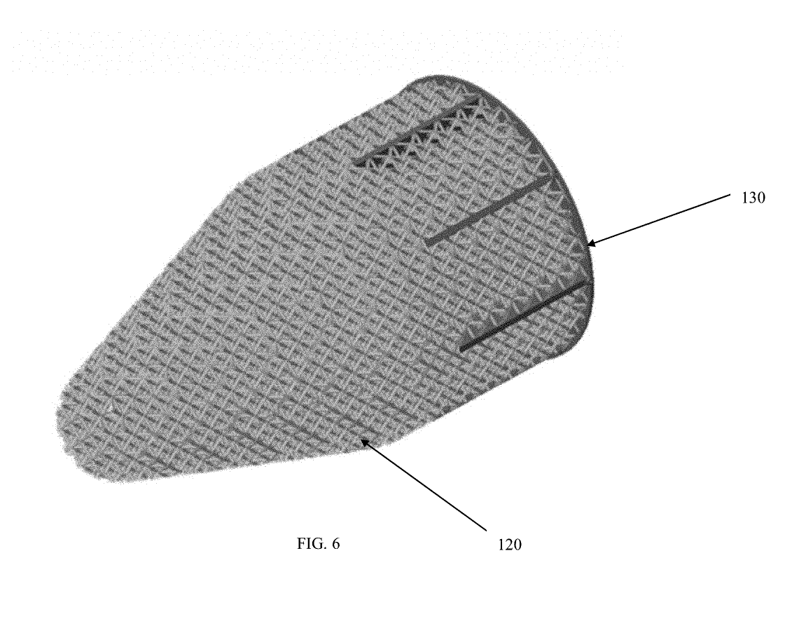

Referring to FIG. 6, a perspective view of one embodiment of a radome according to the principles of the present disclosure, with the outer skin removed is shown. More particularly, a radome having a lattice structure 120 is used in combination with an RF antenna array. The radome skin is removed to clarify and highlight the fact that the radome component and antenna array are combined through a simple assembly step.

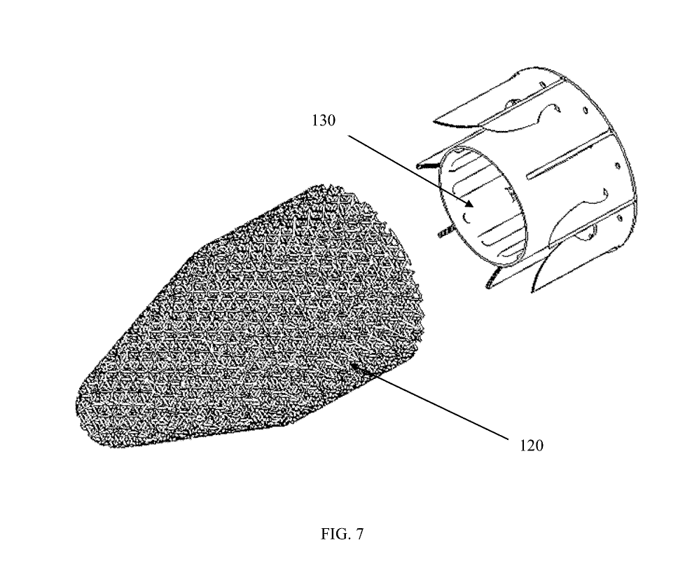

Referring to FIG. 7, an expanded perspective view of one embodiment of a radome shown in FIG. 6 according to the principles of the present disclosure, with the outer skin removed is shown. More particularly, a radome having a lattice structure 120 manufactured using additive manufacturing is used in combination with an RF antenna array. A simple assembly step combines the two portions, thus saving time and money. The resultant structures are lighter and mechanically stronger that conventional radomes of syntactic foam. The resultant structures are also tunable depending on the particular application. The structures possible according to the present disclosure approximate “structured air.” These structures have low-K, approaching that of air, while providing rigidity and structural integrity to protect the RF components.

In certain embodiments, the bulk material used may introduce some absorption of RF signals, but not scattering. In certain cases, the loss for the RF component is tunable based on the selection of bulk material. In some cases, the loss for the RF component is tunable based on the lattice structure chosen. In some embodiments, the component will be designed using materials with particular dielectric constants, unit cells, lattice structures, volume fractions, and the like.

In some cases, low loss, low dielectric structures for use in RF, radome and impedance matching applications will lend themselves to the use of gradients. In some cases, a high dielectric value near the antenna might taper off to a dielectric similar to air at the extent of the radome. In these cases, the gradient could be manufactured to significantly reduce loss and backscattering as compared to discrete interfaces between different regions in a traditional method.

While various embodiments of the present invention have been described in detail, it is apparent that various modifications and alterations of those embodiments will occur to and be readily apparent to those skilled in the art. However, it is to be expressly understood that such modifications and alterations are within the scope and spirit of the present invention, as set forth in the appended claims. Further, the invention(s) described herein is capable of other embodiments and of being practiced or of being carried out in various other related ways. In addition, it is to be understood that the phraseology and terminology used herein is for the purpose of description and should not be regarded as limiting. The use of “including,” “comprising,” or “having,” and variations thereof herein, is meant to encompass the items listed thereafter and equivalents thereof as well as additional items while only the terms “consisting of and “consisting only of are to be construed in a limitative sense.

The foregoing description of the embodiments of the present disclosure has been presented for the purposes of illustration and description. It is not intended to be exhaustive or to limit the present disclosure to the precise form disclosed. Many modifications and variations are possible in light of this disclosure. It is intended that the scope of the present disclosure be limited not by this detailed description, but rather by the claims appended hereto.

A number of implementations have been described. Nevertheless, it will be understood that various modifications may be made without departing from the scope of the disclosure. Although operations are depicted in the drawings in a particular order, this should not be understood as requiring that such operations be performed in the particular order shown or in sequential order, or that all illustrated operations be performed, to achieve desirable results.

While the principles of the disclosure have been described herein, it is to be understood by those skilled in the art that this description is made only by way of example and not as a limitation as to the scope of the disclosure. Other embodiments are contemplated within the scope of the present disclosure in addition to the exemplary embodiments shown and described herein. Modifications and substitutions by one of ordinary skill in the art are considered to be within the scope of the present disclosure.

What is claimed:

1. A method of manufacturing periodic structures to achieve effective low-k and low loss materials in radio frequency applications comprising:
providing a layer of bulk material;
providing a subsequent layer of bulk material onto the layer of bulk material;
bonding the layer of bulk material to the subsequent layer of bulk material using additive manufacturing methods; and
repeating the process to form a three-dimensional component comprising a lattice and having an overall dielectric constant that is lower than that of the bulk material.

2. The method of manufacturing periodic structures to achieve effective low-k and low loss materials in radio frequency applications according to claim 1, wherein the lattice comprises repeating unit cells.

3. The method of manufacturing periodic structures to achieve effective low-k and low loss materials in radio frequency applications according to claim 1, wherein the additive manufacturing method is stereolithography.

4. The method of manufacturing periodic structures to achieve effective low-k and low loss materials in radio frequency applications according to claim 1, wherein the bulk material further comprises a dopant.

5. The method of manufacturing periodic structures to achieve effective low-k and low loss materials in radio frequency applications according to claim 1, wherein the component is a radome and/or antenna aperture.

6. The method of manufacturing periodic structures to achieve effective low-k and low loss materials in radio frequency applications according to claim 1, wherein the periodic structure further comprises a spatial gradient.

7. A periodic structure for use in radio frequency applications comprising: a three-dimensional component manufactured using additive manufacturing comprising a lattice and having a dielectric constant that is lower than that of a bulk material used to manufacture the component.

8. The periodic structure for use in radio frequency applications according to claim 7, wherein the lattice comprises repeating unit cells.

9. The periodic structure for use in radio frequency applications according to claim 7, wherein the method of additive manufacturing is stereolithography.

10. The periodic structure for use in radio frequency applications according to claim 7, wherein the bulk material further comprises a dopant.

11. The periodic structure for use in radio frequency applications according to claim 7, wherein the component is a radome.

12. The periodic structure for use in radio frequency applications according to claim 7, wherein the periodic structure further comprises a gradient.
